(19) United States
(12) Patent Application Publication
(10) Pub. No.: US 2002/0165769 A1
(43) Pub. Date: Nov. 7, 2002

(54) Image forming system capable of printing guidance information including map with information on specials

(76) Inventors: Takeshi Ogaki, Tokyo-To (JP); Akinori Iwase, Yokosuka-Shi (JP); Kazuhiro Ogura, Kawasaki-Shi (JP); Tatsuya Haraguchi, Yokohama-Shi (JP)

Correspondence Address: Johnny A. Kumar, FOLEY & LARDNER, Washington Harbour, 3000 K Street, N.W., Suite 500, Washington, DC, 20007-5109, US

(21) Appl. No.: 09/848,621

(22) Filed: May 4, 2001

(51) Int. Cl. G06F 17/60

(52) U.S. Cl. 705/14; 705/16

(57) ABSTRACT

This invention is a system in combination of a POS system for managing data on goods purchased at a store in which a terminal of a sales management system is set and data on the demographics of customers who have made a purchase, an image forming system capable of printing out a sheet of paper arranged on which are guidance information including a map indicating a route to the place of a advertiser selected by an information selector, advertisement information on the advertiser and information on specials such as coupons, and a statistical data processor, for the advertiser to provide customers with detailed information that matches the demand of the customers for larger advertising efficiency. This combination proposes a guidance information providing system using a statistical processing function of a POS system as much as possible in combination of the POS system as a sales management system and an MFP as a multi-functional image retrieving and forming apparatus.

### BACKGROUND OF THE INVENTION

The present invention relates to an image forming system capable of printing guidance information including a map with information on specials. Particularly, this invention relates to an image forming system set at places, such as a convenience store people often go to, by a sponsor for attracting new customers, that prints out maps and leaflets on musical concert, etc., with information on specials.

There have been proposed several types of system for providing printed outputs in combination of maps and advertisements to be used as advertising media. Japanese Unexamined-Patent Publication No. 11-328222, for example, discloses an information retrieval terminal with a printer set at places people often go to that prints out a map indicating a route to a designated store, and discount and free coupons, etc., offered by the store.

Japanese Unexamined-Patent Publication Nos. 11-126021, 11-216165 and 11-328531 disclose flyers, or printed outputs having a map indicating region on which a map is to be printed, an advertisement indicating region on which several advertisements are to be printed and a coupon indicating region. Moreover, Japanese Unexamined-Patent Publication No. 11-237855 discloses a guidance system for displaying a map from the present location of a user to a destination entered using a telephone number and also printing the map.

Such systems for displaying guidance information and guidance systems having an image forming function of printing displayed maps are mostly set at places people often go to such as convenience stores, shopping centers, department stores and game parlors. A point-of-sales (POS) system is introduced in such places (the center of sales) people often go to for managing data on sales, stocks and the demographics of customers.

The POS system achieves automatic sales activity at department stores, supermarkets and convenience stores, and so on, with several types of terminals, displays and data networks. In detail, the POS system manages sales record and goods as well as identification of customer credit cards, authentication of credit or settlement via computers in banks over a network. The POS system is also called a point-of-sales data system.

Systems for providing printed outputs in combination of maps and advertisements described above provide standard information with no consideration of the demographics of customers. Advertisers thus have difficulty in knowing the effect of advertisements. Moreover, it is difficult to improve the system for offering more effective and detailed information. If advertisers can know the demographics of customers, they can provide more detailed information to meet the demands of customers and hence expect large advertising effects.

Systems for providing printed outputs in combination of maps and discount or free coupons do not provide any information that coupons issued at which place have really been mostly used, so that advertisers cannot have high advertising efficiency. The present invention focuses on the combination of the above systems and the POS system used in many stores for measuring advertising efficiency based on the customer data and offering high advertising efficiency to advertisers.

### SUMMARY OF THE INVENTION

A purpose of the present invention is to provide an image forming system for printing out guidance information such as maps with information on specials that meets the demands of customers based on the demographics of customers, such as age and sex under the combination of multi-functional peripherals and the POS system.

In order to attain the purpose, according to a basic structure of the present invention, an image forming system capable of printing out guidance information including a map with information on specials having a sales management system for managing sales at a specific point while controlling commodity sales and customer data via a terminal set in a store and an image forming unit having at least an image printing function, guidance information including a map being selectively formed and printed with information on specials by the image forming unit, the image forming system including: an information selector that selects and combines advertisement information offered by an advertiser, guidance information including information having a name, a place, a route and a telephone number for designating the advertiser and information on specials including coupons to be used in purchasing goods or taking advantage of service offered by the advertiser; a statistical data processor that issues a receipt ID based on commodity purchase and customer demographic data entered via the sales management system and retrieves commodity and customer data using the receipt ID for statistical processing; and a database including a map and advertisement database for storing guidance and advertisement data, a commodity and customer database for storing commodity and customer data used for the statistical processing and a statistical data database for storing statistical data after processed by the statistical processing, wherein the image forming unit prints out a leaflet having edited information of the advertisement and guidance information and the information on specials selected by the information selector based on a result of the statistical processing performed by the statistical data processor.

In the image forming system according to the basic structure, it is preferable that, based on statistical data output by the statistical data processor, the information selector selects the content and a period of validity from those related to specials corresponding to goods or services offered by the advertiser in accordance with an amount of money used for purchasing at the store in which the terminal of the sales management system has been set and the image forming unit prints out the selected and edited information.

Moreover, in the image forming system according to the basic structure, it is preferable that the statistical data processor informs the store of the fact that, under the advertiser, users have actually taken advantage of specials, including coupons selected and edited by the information selector, for automatic accounting of utilization of the information on specials.

Moreover, in the image forming system according to the basic structure, the statistical data processor may be configured as a first structure in that it informs the store of the fact that, under the advertiser, users have actually taken advantage of specials including coupons issued at the store and checks demographic data on users and obtained at the store and the information that the users have taken advantage of specials sent from the advertiser, for accounting processing of data including frequency of utilization.

Moreover, in the image forming system according to the first structure, it is preferable that the statistical data processor informs the advertiser of a result of the accounting processing.

Moreover, in the image forming system according to the basic structure, it is preferable that the statistical data processor automatically controls the amount of data related to the advertiser and to be printed at the store based on a result of the accounting processing.

Moreover, in the image forming system according to the basic structure, it is preferable that the image forming unit automatically charges not a user but the advertiser for a fee related to the guidance information including a map indicating a route to the advertiser and printed at the store in accordance with the amount of data printed in relation to the advertiser.

In the image forming system according to the basic and the first structure according to the present invention as configured above, costs for printing out map information that attracts customers and installation of a printing apparatus are charged to an advertiser who have gotten new customers. The printed data includes specials such as discount and free coupons. Stores offer spaces for installing the printing apparatus. Users have known that they can take advantage of specials for free at the stores and can get printing out service according to need. The advertiser expects the effect of customer attracting. The stores get a chance to sell goods to the users who go to for the purpose of the printing out service. The users can get information on the place of the advertiser and a route thereto, related information, information on the periphery and take advantage of specials.

The image forming system according to a second structure according to the present invention, in addition to the basic structure, further includes: a reception controller that controls reception of information that users have taken advantage of specials sent from the advertiser for the statistical data processor; and a transmission controller that controls transmission of statistical data and printing charge information from the statistical data processor to the store.

In the image forming system according to the second structure, it is preferable that the image forming unit includes an MFP having at least image printing and retrieving functions, and at the store in which a terminal of a POS system as the sales management system having a sales and customer data recording function, the MFP printing out a map indicating a route to the advertiser designated by a name, a place or a telephone number, advertisements for a destination or surrounding stores and information on specials including coupons that can be used at a destination or surrounding stores.

Moreover, in the image forming system according to the above structure, it is preferable that the image forming unit prints out a map corresponding to the advertiser by entering an identification number for identifying the advertiser at the store or retrieving an advertisement thus printed out.

The image forming system according to a third structure according to the present invention, in addition to the basic structure, further includes: an MFP as the image forming unit having the image printing and retrieving functions; a POS system as the sales management system having a sales and customer data recording function; and a wireless communications system allowing data transfer between a convenience store as the store having the POS system and the MFP and the POS system, wherein the MFP prints out a map information indicating a route to the advertiser designated by a name, a place or a telephone number, advertisements for a destination or surrounding stores and information on specials including coupons that can be used at a destination or surrounding stores.

Moreover, in the image forming system according to the third structure, it is preferable that a map indicating a route to the advertiser designated beforehand is printed out by the MFP set at the store designated beforehand according to remote instruction sent by a wireless communications instrument of the wireless communications system.

Moreover, in the image forming system according to the third structure, it is preferable that the MFP has a image retrieving function, a map indicating a route to the advertiser being printed out by entering an identification number for identifying the advertiser at the store or retrieving an advertisement thus printed out.

### BRIEF DESCRIPTION OF DRAWINGS

FIG. 1 shows a block diagram indicating the basic concept of the present invention;

FIG. 2 shows an illustration of a leaflet with information on specials output by an image forming system according to the present invention;

FIG. 3 shows a basic block diagram of a first preferred embodiment of an image forming system according to the present invention;

FIGS. 4A, 4B and 4C are flow charts indicating operations on the customer side, printing and statistical processes, respectively;

FIG. 5 shows a block diagram of a second preferred embodiment of an image forming system according to the present invention; and

FIG. 6 shows a block diagram of a third preferred embodiment of an image forming system according to the present invention.

### DETAILED DESCRIPTION OF PREFERRED EMBODIMENTS

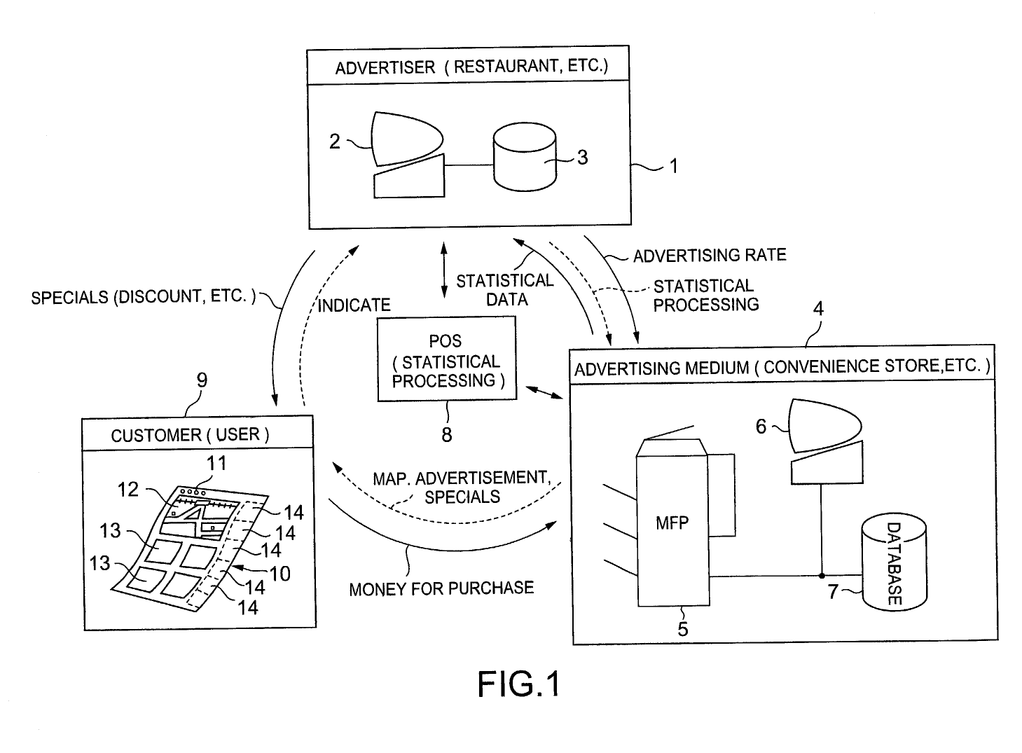

Preferred embodiments of an image forming system for printing out guidance information including a map with information on specials according to the present invention will be disclosed with reference to the attached drawings. FIG. 1 shows the conceptual diagram of a privilege-added guidance information image forming system.

In the conceptual diagram (FIG. 1), a numeral 1 denotes an advertiser such as a restaurant, a destination for customers. The advertiser 1 has a means 2 for informing that a customer has taken advantage of specials, a database 3 for storing the data input by the informing means 2. A store 4 such as a convenience store as an advertising medium has a multi-functional printer (MFP) 5, a display 6 and a database 7. The store 4 that is connected to a POS system 8 having a statistical processing function uses commodity data and customer data, etc., for the statistical processing while generating guidance information such as a map with information on specials. A customer 9 receives a leaflet 10 printed with special-added guidance information.

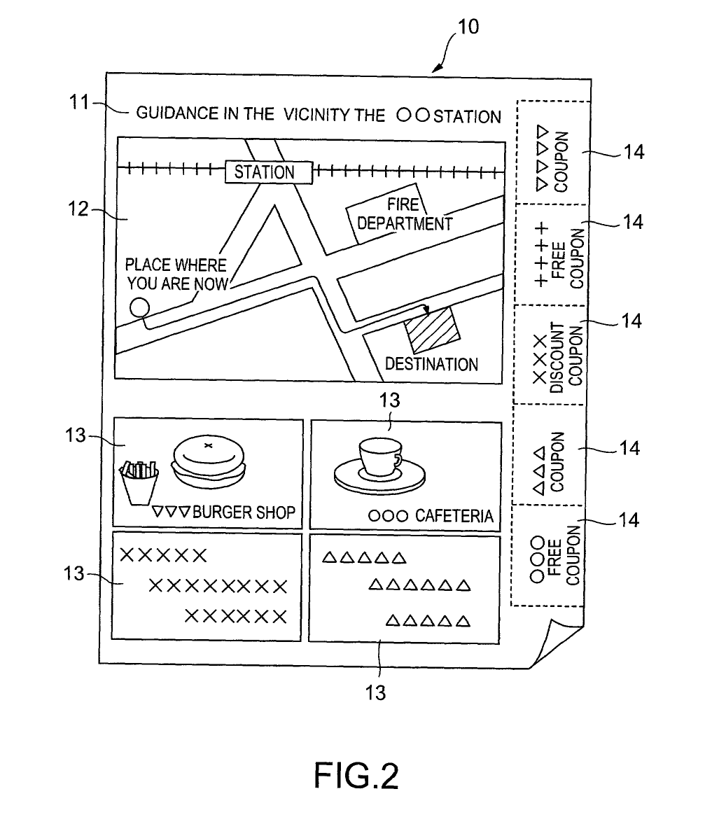

The leaflet 10 has, as illustrated in FIG. 2, a header 11 indicating a title of the leaflet, guidance information 12 such as a map, advertisements 13 provided by an advertiser 1 and printed below the guidance information 12, and information on specials 14 printed along the advertisements 13. A guidance map in the vicinity of the ∘∘ station is the main information in the example shown in FIG. 2. The customer 9 displays a guidance map to a concert hall, etc., on the display 6 set in the store 4 such as a convenience store and prints it out if he or she wants to have one. Demographic data such as sex is entered via numeric keys (not shown) for printing the advertisements 13 which seem to attract the customer 9 below the guidance information 12 such as a map. Printed simultaneously are the information on specials 14 with perforations, such as, coupons which can be used in a shop such as a hamburger shop indicated on one of the advertisements 13. The information 14 may include a discount ticket for a concert which will be held in a couple of days at the concert hall that is the destination indicated in the guidance information 12 such as a map.

Disclosed next with respect to FIG. 1 again is an operation executed by the components shown therein. When the customer 9 goes to the store 4, carrying the map 10 with information of specials and advertisements, the store 4 informs the POS system 8 of the fact that the customer 9 has taken advantage of specials. The store 4 receives statistical data such as the frequency of taking advantage of specials from the POS system 8 for high advertising efficiency. Advertisers pay advertising fees and printing fees for printing out a map with information on specials and advertisements to the store 4 while offering the specials 14 to the customer 9 to stimulate his or her eagerness to purchase.

The store 4 such as a convenience store that offers advertising media gets advertising fees from the advertiser 1 for offering the customer 9 with a map with information on specials and advertisements so that the customer 9 can have a chance to go to the store 4 to make a purchase. The customer 9 may be motivated to buy goods as many as possible for taking grater advantage of specials 14 such as free and discount coupons.

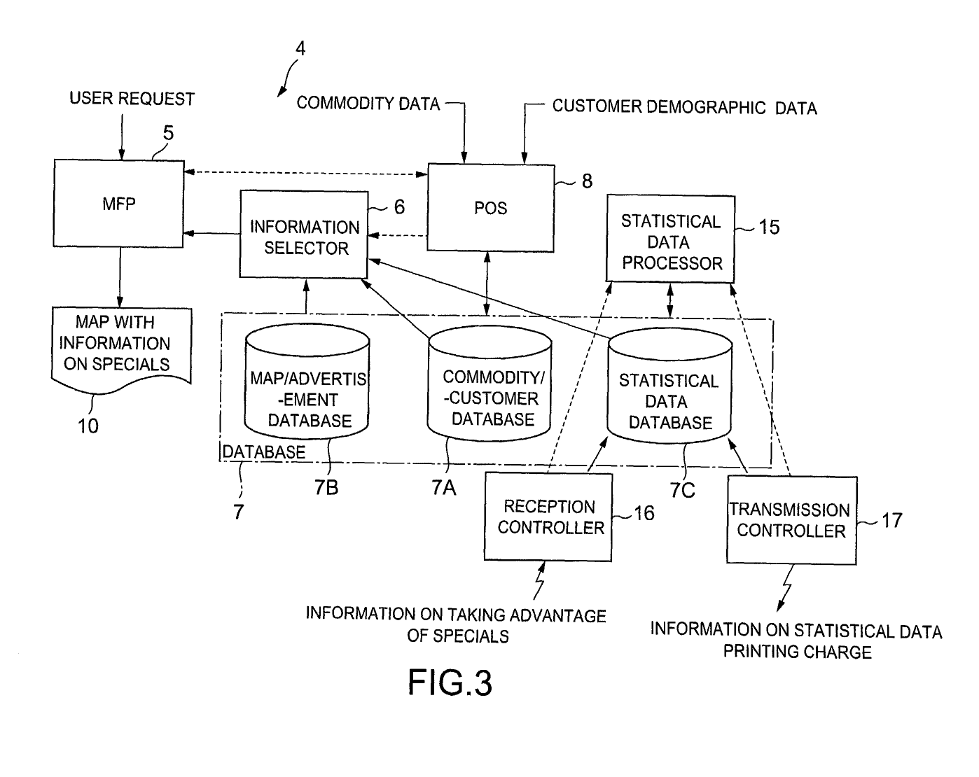

The customer 9 is an average user and can get the special- and advertisement-added guidance information 10 such as a map for free without paying a printing free and take advantage of specials. As shown in FIG. 3, the store 4 has a printing and image readable apparatus (for example, MFP) 5, an information selector 6 for selecting advertising information to be printed out based on commodity, customer and statistical data, a database 7 for storing several kinds of data, and a system (for example, POS) 8 for storing and managing sales and customer data. The database 7 includes commodity/customer database 7A for managing sales and customer data, etc., a database 7B for managing map and advertising data and a database 7C for managing statistical data.

Moreover, the store 4 has a statistical data processor 15 for performing statistical processing based on commodity and customer data, etc., periodically or when receiving information on someone having taken advantage of specials, a reception controller 16 for receiving and processing the information on someone having taken advantage of specials and a transmission controller 17 for transmitting statistical data and printing charges. The store 4 provides the customer 9 with services explained later for gaining a chance to make a sale.

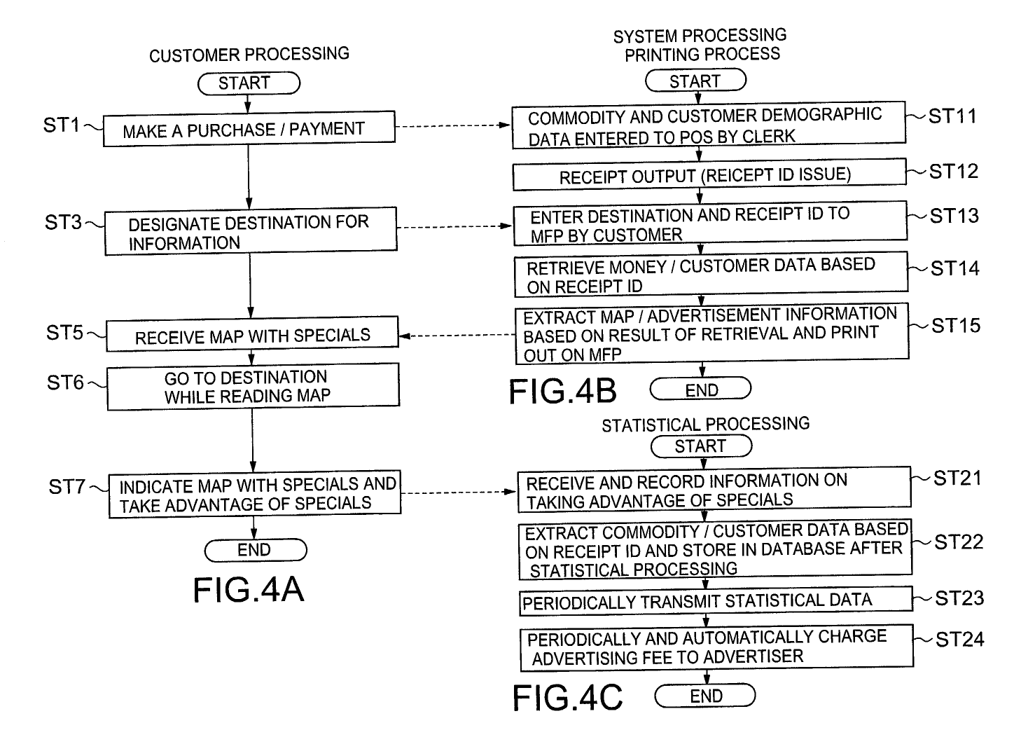

Disclosed with respect to flow charts shown in FIGS. 4A, 4B and 4C are operations of the present system when a customer prints out the special-added guidance information illustrated in FIG. 2. Firstly, the customer 9 buys a commodity and pays for it in step ST1 as indicated in the flow chart of FIG. 4A. In response to this, as shown in FIG. 4B, a clerk enters commodity and customer demographic data to the POS system 8 in step ST11 in the present system for printing out special-added guidance information. On entering the data, a receipt is output and a receipt ID is issued by a terminal of the POS system 8.

The customer 9 receives the receipt ID-added receipt issued by the terminal of the POS system 8. When the customer 9 designates the name, place or telephone number of the advertiser 1 though which he or she wants to get a map or take advantage of specials in step ST3 in FIG. 4A, in the system in FIG. 4B, the MFP 5 is operated for entering a receipt-ID number in step ST13, and the amount of money for payment and customer data, etc., are searched based on the receipt ID in step ST14. Next, as shown in step ST15 in FIG. 4B, map and advertisement data are extracted via the information selector 6 based on the result of searching in step ST14 and output to the MFP 5 for printing out the reflet 10 including guidance information such as a map having necessary information. The reflet 10 is printed out with guidance information through the operations described so far.

Next, as shown in FIG. 4A, the customer 9 receives special- and advertisement-added map information on the designated advertiser 1 in step ST5, so that he or she can go to the destination with the aid of the map in step ST6 and shows the special-added map for taking advantage of specials in step ST7. Advantages taken in step ST15 may be varied according to the amount of money on receipt, or the price of commodity purchased. The customer 9 takes advantage of specials from the advertiser 1 by requesting it printed on the map.

The advertiser 1 enters information on someone having taken advantage of specials with a store number and a receipt number. In step ST21, the statistical data processor 15 receives the information on someone having taken advantage of specials entered by the advertiser 1 after step ST7. The image forming system with information on specials according to the present invention performs the statistical processing on receiving and recording the information. In FIG. 4C, when the customer 9 buys a commodity and pays for it, a clerk enters the type of commodity and customer demographic data (such as age, sex and apparent occupation) so that the total sales amount and customer data are stored in the database 7 connected to the POS system 8.

Disclosed next is the statistical processing operation shown in FIG. 4C. The statistical data processor 15 and the statistical data database 17 are connected to each other for reciprocal data transfer as shown in FIG. 3. The statistical data processor 15 further receives information on someone having taken advantage of specials via the reception controller 16 and outputs statistical data and printing charges via the transmission controller 17. In step ST21, the information on someone having taken advantage of specials is received and recorded based on the data entered by the advertiser 1 that is the destination for the customer 9. In step ST22, commodity and customer data, etc., are retrieved based on the receipt-ID, processed by the statistical data processor 15 and stored in the database 7C. The statistical data is periodically transmitted via the transmission controller 17 in step ST23, and advertising fees are periodically and automatically charged to the advertiser 1 in step ST24.

A receipt output by the terminal of the POS system 8 is handed to the customer 9, with a store number and a receipt number, etc., indicated thereon. The customer 9 operates the MFP 5 to designate the advertiser 1 for taking advantage of specials, gaining advertisements and maps, etc., by entering the name of destination, place, telephone number or identification number shown in reflet in addition to the receipt number. In the present system, sales and customer demographic data are retrieved based on the receipt number, the result of retrieval is sent to the information selector for retrieving information on specials according to the amount of money for payment and advertisements according to the customer demographic data from the map/advertisement database, thus a special- and advertisement-added map on the advertiser 1 being printed out.

For example, when the total amount of money for purchasing at the store 4 is less than ¥1,000, ¥1,000 or more but less than ¥3,000, and ¥3,000 or more, ¥50-, ¥100- and ¥150-discount, respectively, are automatically selected as specials at the information selector and printed out with a map.

When customer demographic data entered by a clerk via the POS system in the store 4 is, for example, a male at the age of early twenty-th, based on the data that customers belonging to the same demography have a tendency to which destination often go to or of which specials take advantage, a map is printed out with the corresponding advertisement located at the best place in priority. Both the special and the advertisement information may be printed out with a map.

On receiving information on someone having taken advantage of specials with destination and receipt numbers at the reception controller at the destination determined according to a store number, the receipt number is sent to the statistical data processor for performing the statistical processing to the corresponding data retrieved from the statistical data database and up-dating the statistical data. The statistical data processor further automatically counts the frequency of taking advantage of specials at the advertiser 1 for statistical processing to know the customers belonging to which demography have taken advantage of specials.

In detail, the statistical data processor up-dates the statistical data based on the history of the dates and frequency of taking advantage of specials at different destinations from the information on someone having taken advantage of specials received at the reception controller. Simultaneously, the statistical data processor extracts a receipt number from the information on someone having taken advantage of specials and retrieves the commodity and customer data corresponding to the receipt number from the commodity/customer database to get the history of the frequency of taking advantage of specials for statistical data up-dating.

According to the statistical data thus obtained, it is known at which advertiser 1 customers have mostly taken advantage of specials indicated on special- and advertisement-added map printed out at the store 4. Moreover, According to the statistical data thus obtained, it is known that customers belonging to which age and sex group have mostly taken advantage of specials among customers who went to the store 4 and made a purchase. The statistical data allows the information selector 6 for selecting information.

The results of automatic counting and statistical processing are automatically informed to the advertiser 1 via the transmission controller 17. The advertiser 1 can know the effect of advertisements according to this feedback. The results of statistical processing informed from several stores 4 can be compared with each other to know that special- and advertisement-added maps printed out at which shop 4 has the highest probability of attracting customers. The advertiser 1 can change weighting of providing advertising information over stores under this information for enhanced advertising efficiency. Costs for printing out special- and advertisement-added maps are also periodically and automatically informed and charged.

The information selector 6 has the following functions: The basic functions are to retrieve map and advertisement data from the map and advertisement database, lay out these data and print out on a sheet of paper. The important points in information selection are as follows: The measure point is the total amount of money used for purchasing, or changing the information on specials added to maps according to the total amount of money. The other point is the frequency of taking advantage of specials, or laying out advertisements in printing in order of priority according to the frequency. A still another point related to this point is customer demographic data, or laying out advertisements in printing in order of destinations or advertisers 1 to which customers belonging to the same demography often go to in printing.

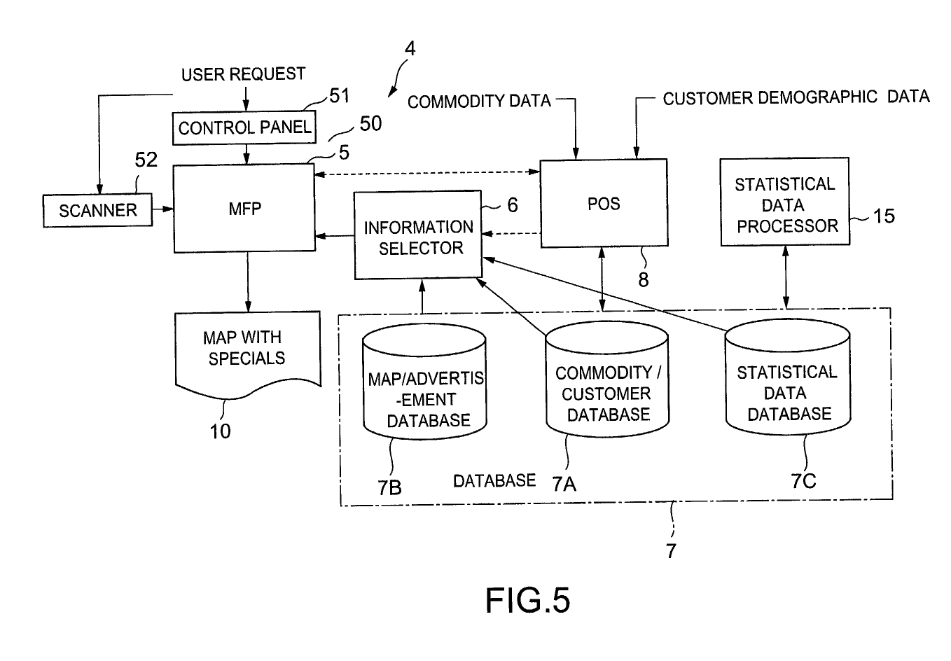

Disclosed next with reference to FIG. 5 is the second preferred embodiment of an image forming apparatus capable of printing out special-added guidance information including a map according to the present invention. The second embodiment of an image forming apparatus includes an MPF (Multiple-Function Peripheral) having an image scanning function in addition to the same structure as the first embodiment of an image forming apparatus shown in FIG. 3.

This embodiment shown in FIG. 5 features an MFP system 50 set in a store 4, provided in which for free are leaflets on which an identification number or barcode for identifying an advertiser 1 (a destination for a customer to visit) and map and advertising information on the advertiser (destination) have been printed. The MPF system 50 has an MPF main frame 5, an MPF control panel 51 for entering identification numbers indicated on leaflets which attract the customer 9 and an MFP scanner 52 for scanning barcodes printed on the leaflets. A destination is designated through the panel 51 and the scanner 52 for printing out the corresponding map and advertisement information.

The information selector 6 searches the map/advertisement database 7B based on the identification number entered via the MFP panel 51 or that gained by recognizing the barcode scanned by the scanner 52 and retrieves the corresponding map and advertisement information for printing out a desired map. This map may be of a special- and advertisement-added map like the one disclosed in the first embodiment.

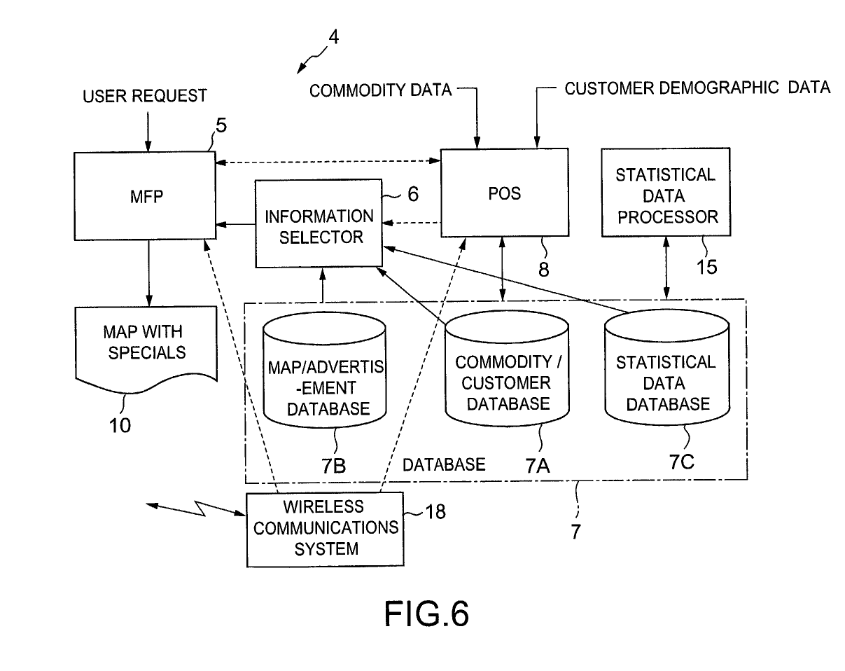

A third preferred embodiment of an image forming system according to the present invention shown in FIG. 6 is provided with a POS system or an MPF having a function of wireless communications in addition to the structure the same as the first embodiment. Provided in FIG. 6 are an MPF 5 that is an image forming unit capable of accepting user command and printing out a leaflet 10 with a special-added map and a wireless communications system 18 that communicates with the POS system 8 as a sales management system for managing sales with the input commodity and customer demographic data, etc.

A user command can be entered to the MFP 5 from a mobile phone network or a personal handyphone system via the wireless communications system 18 for printing out special-added guidance information having a map.

On receiving a print-out inquiry from a wireless communications device such as a mobile phone, the wireless communications system 18 retrieves map and advertisement data on an advertiser 1 designated by the print-out inquiry from the map and advertisement database and prints out a map as the leaflet 10. The leaflet 10 may include not only an advertisement-added map but also a special- and advertisement-added map.

What is claimed is:

1. An image forming system having a sales management system for managing sales at a specific point while controlling commodity sales and customer data via a terminal set in a store and an image forming unit having at least an image printing function, guidance information including a map being selectively formed and printed with information on specials by the image forming unit, the image forming system comprising:
an information selector that selects and combines advertisement information offered by an advertiser, guidance information including information having a name, a place, a route and a telephone number for designating the advertiser and information on specials including coupons to be used in purchasing goods or taking advantage of service offered by the advertiser;
a statistical data processor that issues a receipt ID based on commodity purchase and customer demographic data entered via the sales management system and retrieves commodity and customer data using the receipt ID for statistical processing; and
a database including a map and advertisement database for storing guidance and advertisement data, a commodity and customer database for storing commodity and customer data used for the statistical processing and a statistical data database for storing statistical data after processed by the statistical processing,
wherein the image forming unit prints out a leaflet having edited information of the advertisement and guidance information and the information on specials selected by the information selector based on a result of the statistical processing performed by the statistical data processor.

2. The image forming system according to claim 1, wherein, based on statistical data output by the statistical data processor, the information selector selects the content and a period of validity from those related to specials corresponding to goods or services offered by the advertiser in accordance with an amount of money used for purchasing at the store in which the terminal of the sales management system has been set and the image forming unit prints out the selected and edited information.

3. The image forming system according to claim 1, wherein the statistical data processor informs the store of the fact that, under the advertiser, users have actually taken advantage of specials, including coupons selected and edited by the information selector, for automatic accounting of utilization of the information on specials.

4. The image forming system according to claim 1, wherein the statistical data processor informs the store of the fact that, under the advertiser, users have actually taken advantage of specials including coupons issued at the store and checks demographic data on users and obtained at the store and the information that the users have taken advantage of specials sent from the advertiser, for accounting processing of data including frequency of utilization.

5. The image forming system according to claim 4, wherein the statistical data processor informs the advertiser of a result of the accounting processing.

6. The image forming system according to claim 4, wherein the statistical data processor automatically controls the amount of data related to the advertiser and to be printed at the store based on a result of the accounting processing.

7. The image forming system according to claim 1, wherein the image forming unit automatically charges not a user but the advertiser for a fee related to the guidance information including a map indicating a route to the advertiser and printed at the store in accordance with the amount of data printed in relation to the advertiser.

8. The image forming system according to claim 1 further including:
a reception controller that controls reception of information that users have taken advantage of specials sent from the advertiser for the statistical data processor; and
a transmission controller that controls transmission of statistical data and printing charge information from the statistical data processor to the store.

9. The image forming system according to claim 1, wherein the image forming unit includes an MFP having at least image printing and retrieving functions, and at the store in which a terminal of a POS system as the sales management system having a sales and customer data recording function, the MFP printing out a map indicating a route to the advertiser designated by a name, a place or a telephone number, advertisements for a destination or surrounding stores and information on specials including coupons that can be used at a destination or surrounding stores.

10. The image forming system according to claim 9, wherein the image forming unit prints out a map corresponding to the advertiser by entering an identification number for identifying the advertiser at the store or retrieving an advertisement thus printed out.

11. The image forming system according to claim 1 further comprising:
an MFP as the image forming unit having the image printing and retrieving functions;
a POS system as the sales management system having a sales and customer data recording function; and
a wireless communications system allowing data transfer between a convenience store as the store having the POS system and the MFP and the POS system,
wherein the MFP prints out a map information indicating a route to the advertiser designated by a name, a place or a telephone number, advertisements for a destination or surrounding stores and information on specials including coupons that can be used at a destination or surrounding stores.

12. The image forming system according to claim 11, wherein a map indicating a route to the advertiser designated beforehand is printed out by the MFP set at the store designated beforehand according to remote instruction sent by a wireless communications instrument of the wireless communications system.

13. The image forming system according to claim 11, wherein the MFP has a image retrieving function, a map indicating a route to the advertiser being printed out by entering an identification number for identifying the advertiser at the store or retrieving an advertisement thus printed out.
